(19) United States
(12) Patent Application Publication
(10) Pub. No.: US 2013/0229544 A1
(43) Pub. Date: Sep. 5, 2013

(54) IMAGE PROCESSING DEVICE

(71) Applicant: KABUSHIKI KAISHA TOSHIBA, Tokyo (JP)

(72) Inventor: Yosuke BANDO, Kanagawa (JP)

(73) Assignee: Kabushiki Kaisha Toshiba, Tokyo (JP)

(21) Appl. No.: 13/782,443

(22) Filed: Mar. 1, 2013

(30) Foreign Application Priority Data
Mar. 2, 2012 (JP) P2012-046920

(51) Int. Cl. H04N 9/093

(52) U.S. Cl. CPC H04N 9/093
USPC 348/222.1

(57) ABSTRACT

An image processing device includes: a correspondence point calculating unit, an image deformation unit, an image interpolation unit, and an optional image synthesis unit. The correspondence point calculating unit detects a point of the second image that corresponds to each reference point of the first image. The image deformation unit creates an image by moving pixels from a point in the second image to a corresponding reference point to generate a deformed image that has a viewpoint which is in approximate agreement with the viewpoint of the first image. The image interpolation unit generates an interpolated image, which has interpolated pixel values for points in the region of the deformed image where a corresponding point is not detected. The image synthesis unit generates a synthesized image as a synthesis of the first image and the interpolated image.

### CROSS-REFERENCE TO RELATED APPLICATION

This application is based upon and claims the benefit of priority from Japanese Patent Application No. 2012-046920, filed Mar. 2, 2012; the entire contents of which are incorporated herein by reference.

### FIELD

Embodiments described herein relate to an image processing device.

### BACKGROUND

When an image pickup element of the related art that converts incident light to electric charge is used to take a color picture, the RGB color filters on the pixels of the image pickup element are typically arranged in a mosaic (non-overlapping) configuration. However, when this scheme is adopted, the incident light is cut off by the color filters depending on the incident wavelengths, so that the overall light quantity decreases, and thus the overall sensitivity of the image pickup element decreases.

In order to solve the problems of degradation in resolution and color crosstalk caused by the commonly adopted mosaic configuration, people have proposed a scheme in which the incident light is decomposed by a dichroic mirror or prism and plural image pickup elements are adopted to capture the picture. However, in this constitution, as only the specifically selected wavelength can reach the corresponding image pickup element, there is still the problem of overall decreased light quantity. In addition, as plural, non-overlapping image pickup elements are used, it is necessary to have optical elements for guiding the light from a single viewpoint to the plural image pickup elements, so that the overall size of the image pickup system will generally increase.

A previously proposed scheme for achieving an overall small system size and, especially, a thin structure, involves using a luminance image pickup unit for obtaining the luminance and one or several color image pickup units for obtaining the color arranged side by side. In this case, as the color information is obtained from the color image pickup unit, there is no need to arrange the color filters in the path of the luminance image pickup unit, and hence the imaging sensitivity increases.

However, because the color image pickup unit (s) and the luminance image pickup unit have different viewpoints, parallax is generated. The magnitude of the parallax varies with imaging distance, with the parallax angle being greater for closer objects. In consideration of this problem, people have proposed a scheme for minimizing the offset of the color image with respect to the luminance image by arranging the luminance image pickup unit for obtaining the luminance at the center of the device. However, in this case, it is still impossible to fully avoid the offset in the color image with respect to the luminance image caused by parallax because image pickup units are still not in the same location, thus the image pickup units will still have different viewpoints.

### DESCRIPTION OF THE DRAWINGS

FIG. 1 is a diagram illustrating an image pickup device including the image processing device according to a first embodiment of the present disclosure.

FIG. 2 is a diagram illustrating an image pickup unit.

FIG. 3 is a diagram illustrating another image pickup unit.

FIG. 4 is a diagram illustrating a color filter.

FIG. 5 is a diagram illustrating a corresponding point calculating treatment in a corresponding point calculating unit.

FIG. 6 is a diagram illustrating a parallax interpolation treatment in a corresponding point calculating unit.

FIG. 7 is a diagram illustrating an image deformation treatment in an image deformation unit.

FIG. 8 is a diagram illustrating a color interpolation treatment of an image interpolation unit.

FIG. 9 is a diagram illustrating an image processing device according to a second embodiment of the present disclosure.

FIG. 10 is a diagram illustrating an image processing device according to a third embodiment of the present disclosure.

### DETAILED DESCRIPTION

Embodiments of the present disclosure provide an image processing device that can compensate for the parallax/offset of imaging systems with offset image pickup units, for example, a color image pickup unit and a luminance image pickup unit.

In general, one embodiment of the present disclosure will be explained in detail with reference to figures.

The image processing device according to an embodiment of the present disclosure has: a corresponding point calculating part (correspondence point calculating unit), an image deformation part (unit), an image interpolation part (unit), and an optional image synthesis part (unit). The correspondence point calculating unit detects the corresponding point of the second image with respect to the each reference point of the first image. The image deformation unit moves the pixel values at the corresponding points in the second image to the corresponding reference points so as to generate a deformed image that has the viewpoint of the second image which is deformed to almost in agreement with the viewpoint of the first image. The image interpolation unit generates an interpolated image, which has the pixel values of the deformed image interpolated, in the region where the corresponding point is not detected. The image synthesis unit generates a synthesized image as a composition of the first image and the interpolated image.

### First Embodiment

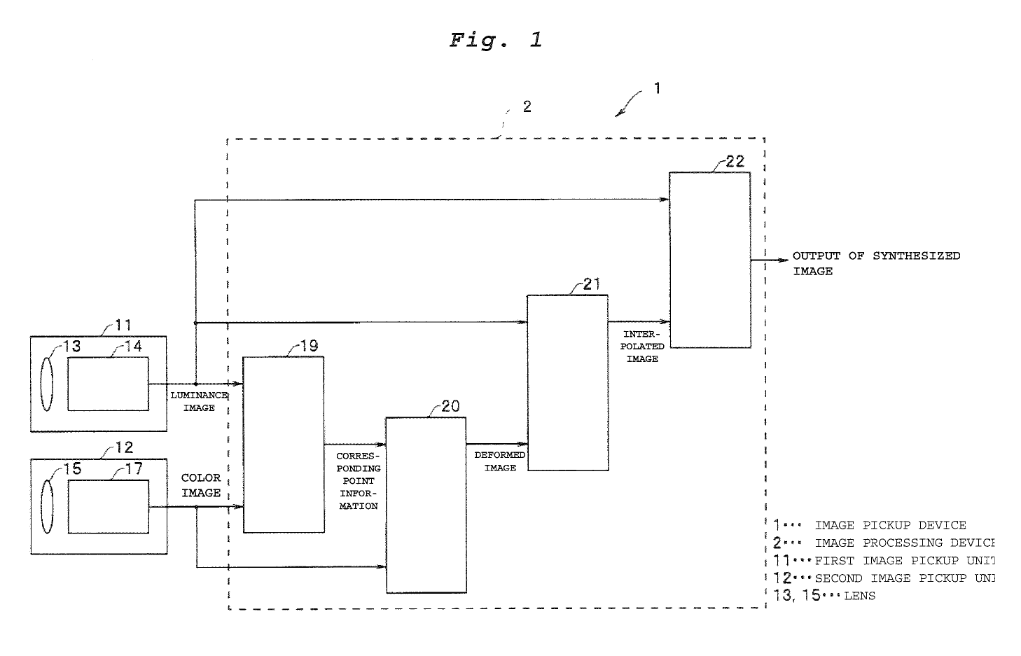

First, with reference to FIG. 1 to FIG. 4, the constitution of the image pickup device possessing the image processing device related to the first embodiment will be explained.

FIG. 1 is a diagram illustrating the constitution of the image pickup device possessing the image processing device related to the first embodiment.

The image pickup device 1 includes a first image pickup unit 11 for obtaining the luminance image (luminance signal), a second image pickup unit 12 for obtaining the color image (color signal), and an image processing device 2. The image processing device 2 includes a corresponding point calculating unit 19, an image deformation unit 20, an image interpolation unit 21, and an image synthesis unit 22.

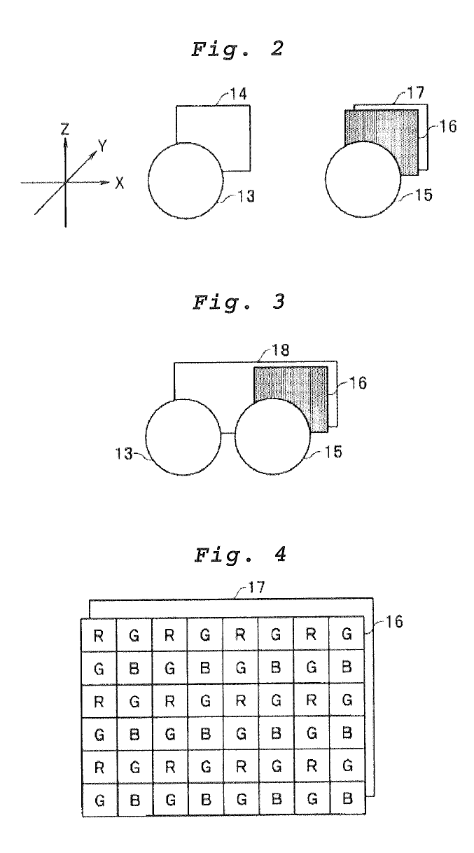

FIG. 2 is a diagram illustrating the constitution of the image pickup unit. The first image pickup unit 11 has a lens 13 and a luminance image pickup part 14. The second image pickup unit 12 has a lens 15, a color filter 16, and a color image pickup part 17. In the present embodiment, the first image pickup unit 11 and the second image pickup unit 12 are arranged side by side in the horizontal direction (X-axis direction). However, it is also possible to arrange them side by side in the vertical direction (Y-axis direction) or in the oblique direction.

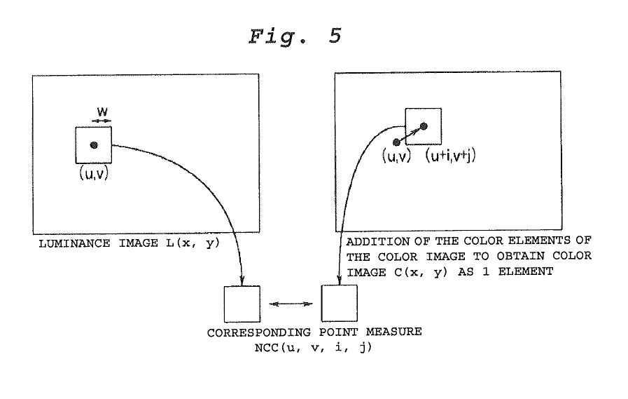

According to the present embodiment, the constitution has two image pickup units, luminance image pickup part 14 and color image pickup part 17. However, one may also adopt a scheme in which the constitution has one image pickup part 18. FIG. 3 is a diagram illustrating an image pickup part combining a luminance image pickup part and color image pickup part. As shown in FIG. 3, the image pickup part 18 is divided into two regions equipped with lenses 13 and 15, respectively, and, at the same time, a color filter 161s arranged only for one region.

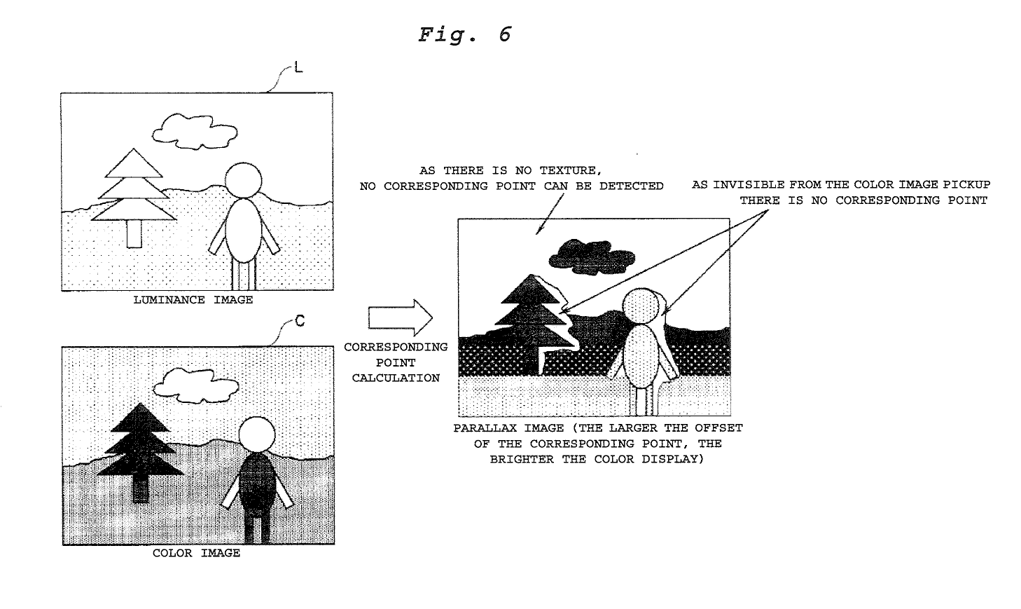

The light from the object is picked up by the lenses 13 and 15. The luminance image pickup part 14 then picks up the luminance image of the object picked up by the lens 13. The color image pickup part 17 picks up the color image of the object through the color filter 16 with, for example, a Bayer configuration. FIG. 4 is a diagram illustrating the constitution of the color filter. As shown in FIG. 4, the Bayer configuration includes the following two types of lines arranged alternately, lines each having R filters and G filters arranged alternately and lines having G filters and B filters arranged alternately. The luminance image pickup part 14 and color image pickup part 17 are, e.g., CCD image sensors or CMOS image sensors.

The luminance image obtained with the luminance image pickup part 14 is input to the corresponding point calculating part 19, the image interpolation unit 22, and the image synthesis part 22. The color image obtained with the color image pickup part 17 is input to the corresponding point calculating part 19 and the image deformation part 20.

The corresponding point calculating part 19 carries out the de-mosaicing treatment for the color image, and, at the same time, for each pixel of the luminance image, it detects the corresponding point in the color image processed with the de-mosaicing treatment. On the basis of the corresponding point information detected by the corresponding point calculating part 19, the image deformation part 20 generates a deformed image that is deformed so that the viewpoint of the color image is in approximate agreement with the viewpoint of the luminance image. For the regions in the deformed image where there is no corresponding point, the image interpolation part 21 generates an interpolated image where those regions are filled with interpolated color. The image synthesis part 22 synthesizes an output color image by combining the luminance image and the interpolated image. As a result, a high sensitivity color image is generated.

In the following, the specific operation of the image processing device of this constitution will be explained with reference to FIG. 5 to FIG. 8.

### (Treatment in the Corresponding Point Calculating Part 19)

FIG. 5 is a diagram illustrating the corresponding point calculating treatment of the corresponding point calculating part 19. As shown in the following listed formula (formula 1), the corresponding point calculating part 19 adds the R, G, and B elements Cc(x, y) (where c=r, g, or b) of the color image processed by de-mosaicing treatment to generate a color image C(x, y) where each pixel has a single value, which is still called a color image for convenience sake.

C(x,y)−Cr(x,y)+Cg(x,y)+Cb(x,y) (formula 1)

Then, as shown in FIG. 5, the corresponding point calculating part 19 calculates to determine which region of the color image C corresponds to the rectangular region (whose area N=(2w+1)²) contained in the range of |w| in each of the x, y directions from each reference point (u, v) of the luminance image L.

Because the image pickup wavelength and sensitivity for the luminance image L are not necessarily in agreement with those for the color image C, a NCC (normalized cross correlation) that takes the correlation of image regions is adopted as the measure of the similarity for the corresponding point. The correlation value when the parallax is assumed to be (i, j) becomes the following listed formula (formula 2). When the first image pickup part 11 and the second image pickup unit 12 are arranged in the horizontal direction, the value of the parallax j in the vertical direction will be 0.

NCC(u,v;i,j)=Σₓε[−w,+w]⇄_{y}ε[−w,+w](L(u+x,v+y)−Lavg)(C(u+i+x,v+j+y)−Cavg)/(σ₁σ_{c})^{1/2} (formula 2)

Here, Lavg and Cavg represent the average value of the pixel values in the rectangular region, and they are represented by the following (formula 3) and (formula 4), respectively. Also, σ1 and σc indicate the variance of the pixel values in the rectangular region, and they are represented by the following (formula 5) and (formula 6), respectively.

Lavg=(1/N)Σₓε[−w,+w]Σ_{y}ε[−w,+w]L(u+x,v+y) (formula 3)

Cavg=(1/N)Σₓε[−w,+w]Σ_{y}ε[−w,+w]C(u+i+x,v+j+y) (formula 4)

σ²₁=(1/N)Σₓε[−w,+w]Σ_{y}ε[−w,+w](L(u+x,v+y)−Lavg)² (formula 5)

σ²_{c}=(1/N)Σₓε[−w,+w]Σ_{y}ε[−w,+w](C(u+i+x,v+j+y)−Cavg)² (formula 6)

Then, as indicated by the following formula (formula 7), the corresponding point calculating part 19 determines the parallax as the (i, j) where the maximum value of NCC is obtained with respect to the parallax candidates [iₘᵢₙ, iₘₐₓ], [jₘᵢₙ, jₘₐₓ].

(i′(u,v),j′(u,v))=arg max iε[imin,imax] jε[jmin,jmax] NCC(u,v;i,j) (formula 7)

Because the parallax depends on the coordinates (u, v) in the luminance image, it is denoted as (i′(u, v), j′ (u, v)). Consequently, the coordinates of the color image C corresponding to the luminance image L(u, v), that is, the corresponding point, becomes (u+i′(u, v), v+j′(u, v)).

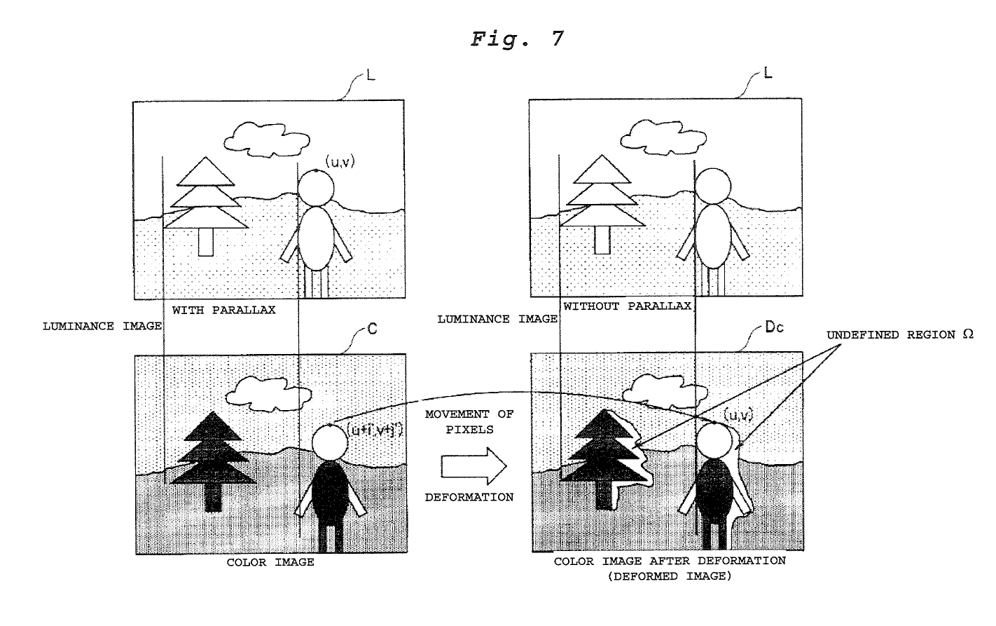

In addition, there are two cases in which the corresponding point calculated by the corresponding point calculating part 19 is uncertain or undefined. In such cases, it is taken that there is no corresponding point. FIG. 6 is a diagram illustrating the parallax interpolation treatment of the corresponding point calculating part. In the first case, there is little variation in the pixel values in the rectangular region (no or little texture), and there are no local image features to correlate. This can be determined by the fact that the variance value al is smaller than some threshold. In the second case, there is a region that is occluded by the object in the scene, so although it is visible from the luminance image pickup part 14, it is invisible from the color image pickup part 17, and the corresponding region with correlation is absent from the color image C. In this case, determination is made from the fact that the maximum correlation max NCC (u, v; i, j) is smaller than some threshold. In these cases, the parallax of a neighboring region that is reliable is adopted for interpolation.

### (Treatment of the Image Deformation Part 20)

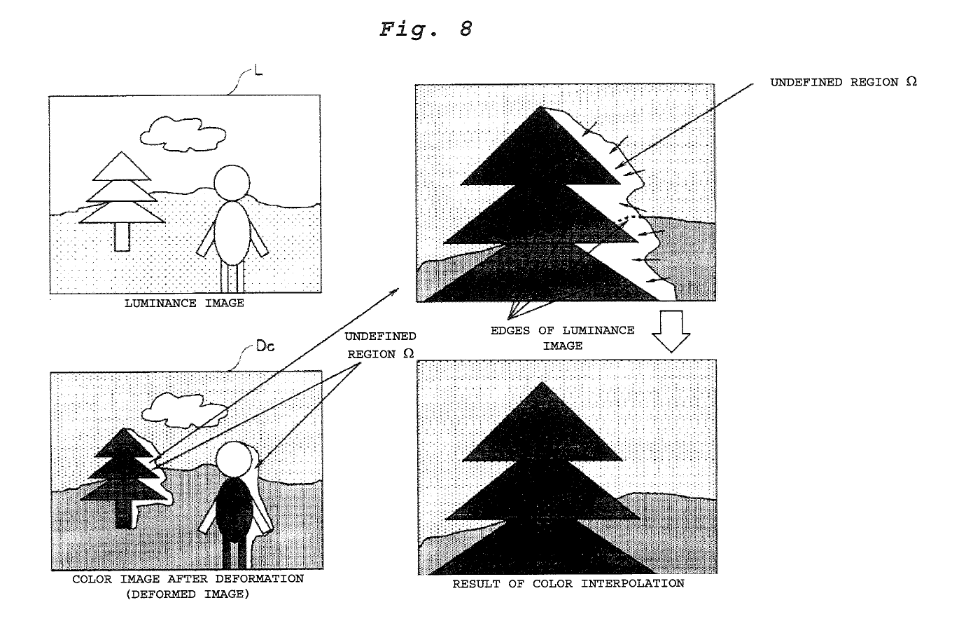

Then, on the basis of the corresponding point information obtained with the corresponding point calculating part 19, the image deformation part 20 deforms the color image C. FIG. 7 is a diagram illustrating the image deformation treatment with the image deformation part 20. Since the viewpoint of the luminance image pickup part 14 is different from that of the color image pickup part 17, as shown in FIG. 7, parallax takes place between the obtained luminance image L and the color image C corresponding to the depth of the scene (imaging distance). Because the corresponding point of the luminance image L (u, v) is the color image C(u+i′, v+j′), the deformed image Dc is given by the following formula (formula 8).

Dc(x,y)=Cc(x+i′(x,y),y+j′(x,y)) (formula 8)

Specifically, the pixel position of the color image C is moved so that the viewpoint of the color image C is approximately in agreement with the luminance image L. Here, the value for the points without a corresponding point is undefined. In this way, for the region out of the undefined region Ω, the viewpoint of the deformed image Dc is almost in agreement with the viewpoint of the luminance image L. In other words, although there is the undefined region Ω, the color image C as seen from the viewpoint of the luminance image pickup part 14 is obtained. That is, as shown in FIG. 7, the deformed image Dc that is (approximately) free of parallax with respect to the luminance image L is obtained by the image deformation part 20.

### (Treatment of the Image Interpolation Part 21)

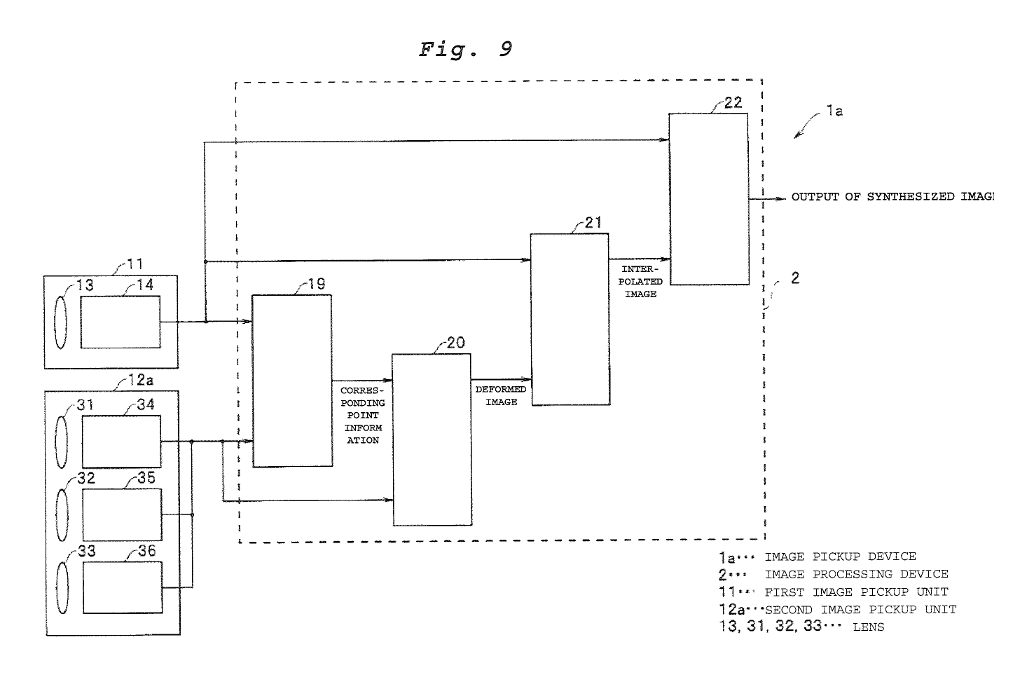

FIG. 8 is a diagram illustrating the color interpolation treatment with the image interpolation part. Here, for the undefined region Ω without corresponding points in the deformed image Dc from the image deformation part 20, the image interpolation part 21 interpolates pixel values from the surrounding region Ω where values exist. In this case, by using the luminance image Las a guide, a natural interpolation result is obtained. More specifically, when the color information is propagated to the undefined region Ω, the propagation velocity depends on the smoothness of the luminance image L. That is, the smoother the luminance image L, the higher the propagation velocity, and, when there is an edge in the luminance image, the propagation velocity decreases. As a result, the color is interpolated smoothly where the luminance image is smooth, and the color difference is maintained without color bleeding where there are edges in the luminance image around the contours of objects and in textured regions.

More specifically, with reference to the region of the luminance image L corresponding to the undefined region Ω in the deformed image Dc, when the luminance difference of this region is large, interpolation of the color of the undefined region Ω is not actively carried out; when the luminance difference is small, the interpolation of color of the undefined region Ω is actively carried out. For example, for the luminance image L shown in FIG. 8, the luminance difference is large at the boundary between the tree and the sky, the boundary between the tree and the ground, and the boundary between the sky and the ground. As a result, in the undefined region Ω in the deformed image Dc, in the periphery of such edges in the luminance image L, interpolation is not actively carried out. On the other hand, for the region of the sky and the region of the ground of the luminance image L, the luminance difference is small, and so in the undefined region Ω in the deformed image Dc, color interpolation of the corresponding regions is actively carried out. As a result, as indicated in the color interpolation result shown in FIG. 8, it is possible to carry out interpolation with the minimal color bleeding at the edges.

First, at the image interpolation part 21, from the RGB image of the deformed image Dc, the chrominance signals U(x, y), V(x, y), shown in the following (formula 9) and (formula 10), are fetched. Here, a, b, and d to g are the prescribed coefficients. As a specific example, they are a=−0.169, b=−0.331, d=0.500, e=0.500, f=−0.419, g=−0.081.

U(x,y)=a Dr(x,y)+b Dr(x,y)+d Db(x,y) (formula 9)

V(x,y)=e Dr(x,y)+f Dg(x,y)+g Db(x,y) (formula 10)

In the following, explanation will be made only of the U(x, y). However, the same treatment is carried out for V (x, y). Interpolation of the chrominance signal U(x, y) is carried out for the undefined region Ω by minimizing the following listed (formula 11) with respect to U(x, y).

Σ_{(x,y)εΩ}(U(x,y)−Σ_{(i,j)εn(x,y)}λ(i,j;x,y)U(i,j))² (formula 11)

Here, n(x, y) refers to a set of neighboring pixels of (x, y). For example, one may use 8 neighboring pixels. λ(i, j; x, y) refers to the weight dictating the similarity between pixel (i, j) and pixel (x, y), which satisfies the relationship of Σ_{(i, j)εn(x, y)}λ(i, j; x, y)=1. Minimization of the (formula 11) means determination of the value of U(x, y) of the undefined region Ω so that U(x, y) and the weighted average of the values U(i, j) of the neighboring pixels are as equal to each other as possible for each set of coordinates (x, y) This is a least square method with the values of the U(x, y) of the undefined region Ω taken as unknown variables, and it can be solved by conventional solution methods for linear equations involving a sparse system matrix (conjugate gradient method, etc.). If the weight λ is homogeneous λ(i, j; x, y)=1/|n(x, y)| (here, |n(x, y)| refers to the number of the neighboring pixels), homogeneous smooth interpolation is carried out. On the other hand, if the value of λ(i, j; x, y) is small, the weight of interpolation is weak, and a difference may be left between the values of U(i, j) and U(x, y). Here, as shown in the following listed (formula 12), when the difference is large between the L(i, j) and L (x, y) of the luminance image L (when there is an edge), λ(i, j; x, y) is set to a small value, and it is possible to carry out interpolation that prevents color bleeding at the edge.

λ(i,j;x,y)=(1/Z(x,y))exp(−(L(i,j)−L(x,y))²/η) (formula 12)

Here, η represents a parameter for adjusting the effect of the edge of the luminance image L, and Z represents normalization for satisfying Σ_{(i, j)εn(x, y)}λ(i, j; x, y)=1, and it is given by the following (formula 13).

Z(x,y)=Σ_{(i,j)εn(x,y)}exp(−(L(i,j)−L(x,y))²/η) (formula 13)

(Treatment with the Image Synthesis Part 22)

The image synthesis part 22 superposes the luminance image Land the chrominance signals U (x, y) and V (x, y) that no longer have undefined region Ω as the result of interpolation with the image interpolation unit 21, and it obtains the synthesized images Sc for R, G, B. The synthesized images Sc (x, y) of R, G, B are given by the following listed formulas, (formula 14), (formula 15) and (formula 16). In addition, h, k, m, o are prescribed coefficients. As an example, they have the following values: h=1.402, k=−0.344, m=−0.714, o=1.772.

Sr(x,y)=L(x,y)+h V(x,y) (formula 14)

Sg(x,y)=L(x,y)+k U(x,y)+m V(x,y) (formula 15)

Sb(x,y)=L(x,y)+o U(x,y) (formula 16)

As explained above, for each pixel of the luminance image obtained with the luminance image pickup part 14, the image processing device 2 detects the corresponding point of the color image obtained with the color image pickup part 17 by means of the corresponding point calculating part 19; on the basis of the detected corresponding point information, a deformed image that is deformed to have the color image in agreement with the content of the luminance image is generated by the image deformation part 20. Then, for the region in the deformed image where there is no corresponding point, the image processing device 2 generates an interpolated image by interpolating the color information using image interpolation part 21, and synthesizes an output color image by combining the luminance image and the interpolated image using image synthesis part 22. Consequently, with the image processing device in this embodiment, it is possible to compensate for the parallax offset of the color image with respect to the luminance image.

The image processing device 2 also carries out image treatment to minimize the parallax generated due to the difference in respective location/perspective of the luminance image pickup part 14 and the color image pickup part 17. Treatment is also carried out for the occluded (occlusion) regions by propagation interpolation of the color of the color image. By consideration of the edges of the luminance image from the luminance image pickup part 14, a synthesized image that looks natural can be obtained.

Moreover, by arranging the luminance image pickup part 14 and the color image pickup part 17 side by side, the image pickup device 1 can minimize the overall image pickup system size, and can make it thinner. In addition, for the image pickup device 1, as there is no need to arrange a color filter in the luminance image pickup part 14, the sensitivity increases.

As the human eyes are relatively insensitive to variation in color, even when the color image pickup part 17 has an image pickup resolution lower than that of the luminance image pickup part 14, perceived degradation in the image quality of the synthesis result is small. Therefore, it is possible to lower the resolution to decrease the pixel number so as to reduce the size of the color image pickup part 17 and to decrease its cost. By decreasing the pixel number, it is also possible to increase the pixel size so as to increase the sensitivity without changing the overall size of the color image pickup part 17. In this case, for the luminance image of the luminance image pickup part 14, the image is downsampled to have the pixel number equal to that of the color image pickup part 17, then the calculation of the corresponding point, deformation, and interpolation is carried out. Next, the obtained interpolated image is enlarged to have its pixel number equal to that of the luminance image, and the synthesis treatment is carried out.

### Second Embodiment

In the following, the second embodiment will be explained.

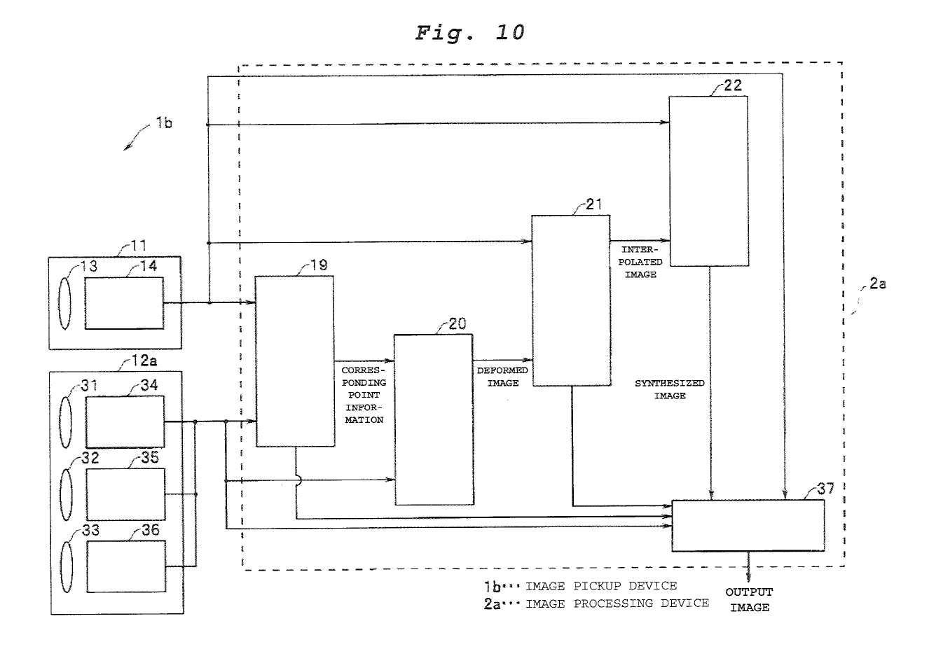

FIG. 9 is a diagram illustrating the constitution of the image pickup device having the image processing device related to the second embodiment. In FIG. 9, the same reference keys as those above in FIG. 1 are adopted, and they will not be explained in detail again.

For the image pickup device la shown in FIG. 9, instead of the second image pickup unit 12 shown in FIG. 1, the second image pickup unit 12a is adopted. The second image pickup unit 12a has three lenses 31, 32, and 33, as well as R image pickup part 34, G image pickup part 35, and B image pickup part 36 for picking up the images of the object taken by these three lenses.

In the R image pickup part 34, the G image pickup part 35, and the B image pickup part 36, an R filter, a G filter, and a B filter, not shown in the figure, are arranged, respectively, to obtain the R image, G image and B image. In addition, it is preferred that the luminance image pickup part 14 be arranged at the center of the R image pickup part 34, G image pickup part 35, and B image pickup part 36 to minimize the offset of the various color images with respect to the luminance image. However, one may also adopt other configurations for the present embodiment.

The correspondence point calculating unit 19, the image deformation part 20 and the image interpolation part 21 carry out the same treatment as that in the first embodiment for the R image, G image, and B image obtained with the R image pickup part 34, the G image pickup part 35, and the B image pickup part 36, respectively. Here, each of the R image, G image, and B image has only a single color element. Consequently, some formulas are changed. In the following, explanation will be made for the R image. In the corresponding point calculating part 19, instead of addition of the elements with (formula 1), the R image Cr(x, y) can be used as it is as: C(x, y)=Cr(x, y). In the image deformation part 20, the (formula 8) adopts Dr(x, y)=Cr(x+i′(x, y), y+j′(x,y)) only on the R element. In the image interpolation part 21, instead of calculating the chrominance using (formula 9), interpolation treatment is carried out for the R image Dr (x, y) deformed with U(x, y)=Dr (x, y). The same treatment is also carried out for the G and B images. The obtained interpolated image is taken as Ec(x, y)(c=r, g, b), and the image synthesis part 22 obtains the RGB image as the synthesis result as Sc(x, y)=Ec(x, y) instead of (formula 14), (formula 15), and (formula 16). Alternatively, with the following listed (formula 17) and (formula 18), from the interpolated image Ec (x, y), the chrominance signals U(x, y) and V (x, y) are extracted similarly to (formula 9) and (formula 10). Then, they are superposed with the luminance image by using (formula 14), (formula 15) and (formula 16), and an image with high sensitivity is obtained.

U(x,y)=a Er(x,y)+b Eg(x,y)+d Eb(x,y) (formula 17)

V(x,y)=e Er(x,y)+f Eg(x,y)+g Eb(x,y) (formula 18)

As a result, with respect to the luminance image obtained by the luminance image pickup part 14, the R image, G image and B image are synthesized by carrying out the corresponding point calculation, image deformation, and image interpolation. The remaining constitution is the same as that of the first embodiment.

For the image processing device 2 with this constitution, by carrying out 3-color pickup with the color image pickup part 17 shown in FIG. 1, it is possible to decrease the color crosstalk, and to improve the color reproducibility. Also, for the image processing device 2, there is no need to carry out the de-mosaicing treatment, and it is possible to increase the image resolution.

As a modified example of the image pickup device 1a, the G image pickup part 35 takes an approximation of the luminance image, and, instead of the luminance image pickup part 14 of the first image pickup unit 11, the (single color) G image pickup part 35 is adopted, and the second image pickup unit 12a is formed as a 2-lens structure including the R image pickup part 34 and the B image pickup part 36. One may also adopt a scheme wherein the second image pickup unit 12a is formed by a 1-lens RB image pickup part with a mosaic RB color filer. In both cases, the image processing device 2 synthesizes the R image and the B image respectively with the minimized parallax with respect to the G image, and they are then synthesized with the G image to obtain an RGB image for output.

One may adopt a scheme in which the first image pickup unit 11 is taken as the color image pickup part, the second image pickup unit 12a is taken as the UV/IR (ultraviolet light and infrared light) image pickup part, and the luminance information is obtained by adding the elements from the color image pickup part as shown in (formula 1), and it is superposed with the invisible light information of the UV/IR image pickup part. Specifically, the image processing device 2 synthesizes the UV and IR images, respectively with the minimized parallax with respect to the luminance image obtained from the color image, and they are synthesized with the color image to output the RGB/UV/IR image. In addition, one may also take the first image pickup unit 11 as the luminance image pickup part and adopt a 2-lens system for the second image pickup unit 12a that includes the color image and the invisible light image pickup units. One may also adopt a scheme whereby the first image pickup unit 11 is taken as the luminance image pickup part and the second image pickup unit 12a is taken as the image pickup part equipped with a polarized filter to form an image pickup system for observing the polarized state of the scene.

In addition, one may also adopt a scheme in which plural second image pickup units 12a are arranged that can obtain the same type of information. For example, when plural color image pickup parts are arranged, it is possible to reduce occluded regions. In addition, by using plural color image pickup parts with varying exposure times or sensitivity, it is possible to synthesize an image by combining images under plural exposure conditions so as to avoid over/under exposures.

### Third Embodiment

FIG. 10 is a diagram illustrating the constitution of the image pickup device possessing the image processing device according to the third embodiment. The same reference keys as those in the above in FIG. 1 and FIG. 9 are adopted in FIG. 10, and they will not be explained in detail again.

For the image processing device 2a shown in FIG. 10, an image selecting part 37 is added to the image processing device 2 shown in FIG. 1 or FIG. 9. FIG. 10 shows the constitution where the image pickup device 1b that has the second image pickup unit 12a including plural image pickup elements, just as in FIG. 9. However, one may also adopt a constitution of the second image pickup unit 12 including a single image pickup part as shown in FIG. 1.

Input to the image selecting part 37 are the synthesized images from the image synthesis part 22, the luminance image from the first image pickup unit 11, and the color image from the second image pickup unit 12a. Also, input to the image selecting part 37 are, the difference in the coordinates between the corresponding points and the reference points, specifically, the parallax information from the correspondence point calculating unit 19, and the chrominance information of the color image from the image interpolation unit 21. On the basis of the input parallax information and chrominance information, the image selecting part 37 selects any of the synthesized image, the luminance image and the color image for output.

When the parallax information is lower than the prescribed threshold, the image selecting part 37 selects and outputs the synthesized image from the image synthesis part 22.

When there are pixels where the parallax information is over the prescribed threshold, the image selecting part 37 determines that the scene contains an object with a very short distance to the first image pickup unit 11 and the second image pickup unit 12a, and it selects and outputs the color image from the second image pickup unit 12a. As a result, although the sensitivity decreases, it is possible to avoid possible errors in the color image interpolation caused by large parallax and large occluded regions.

Also, when there are pixels where the parallax information is over the prescribed threshold and the chrominance information of the color image is lower than the prescribed threshold, the image selecting part 37 determines that a black and white or grey scale object such as a QR Code (registered trademark) is photographed in proximity (short imaging distance), and the image selecting part 37 selects and outputs the luminance image from the first image pickup unit 11. As a result, it is possible to avoid possible errors of color image interpolation caused by large parallax, and, at the same time, it is possible to output the high sensitivity luminance image, that is favorable for reading a QR Code (registered trademark), etc.

As explained above, the image processing device 2a can use the image selecting part 37 to select and output not only the synthesized image but also the luminance image and the color image from the first image pickup unit 11 and the second image pickup unit 12a. As a result, the image processing device 2a can output an appropriate image corresponding to the image pickup state. Also, when the parallax is over a prescribed threshold, only the luminance image or only the color image is output, so that it is possible to prevent errors in color interpolation.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing device, comprising:
a correspondence point calculating unit configured to detect a point in a second image that corresponds to a reference point in a first image;
an image deformation unit configured to adjust a pixel location of the point in the second image that corresponds to the reference point in the first image to generate a deformed image having a viewpoint approximately matching the first image; and
an image interpolation unit configured to generate an interpolated image having interpolated pixel values for points in the deformed image that do not correspond to any points in the first image.

2. The image processing device of claim 1, wherein the first image is a luminance image.

3. The image processing device of claim 1, wherein the second image is a color image.

4. The image processing device of claim 1, further comprising:
an image synthesis unit to generate a synthesized image from the first image and the interpolated image.

5. The image processing device of claim 4, further comprising:
an image selecting unit configured to select an output image from a group of images including the synthesized image, the first image, and the second image, wherein the selection is based on parallax information and chrominance information.

6. The image processing device of claim 1, further comprising:
a first image pickup unit to obtain the first image; and
a second image pickup unit to obtain the second image.

7. The image processing device of claim 6, wherein the second image pickup unit comprises a plurality of image pickup elements.

8. The image processing device of claim 6, wherein the first image pickup unit and the second image pickup unit are disposed on a common substrate.

9. The image processing device of claim 1, wherein the interpolated image is generated by considering differences in pixel values in the first image.

10. An image pickup device, comprising:
a first image pickup unit to acquire a first image from a first viewpoint;
a second image pickup unit to acquire a second image from a second viewpoint;
a correspondence point calculating unit that detects the a point in the second image which corresponds to a reference point in the first image;
an image deformation unit configured to adjust a pixel location for the point in the second image that corresponds to the reference point in the first image to generate a deformed image having a viewpoint approximately matching the first viewpoint; and
an image interpolation unit configured to generate an interpolated image having interpolated pixel values for points in the deformed image that do not correspond to any points in the first image.

11. The image pickup device of claim 10, wherein the first image pickup unit and the second image pickup unit share a common substrate.

12. The image pickup device of claim 10, wherein the second image pickup unit comprises a plurality of image pickup elements.

13. The image pickup of device of claim 10, wherein the second image pickup unit detects ultraviolet or infrared light.

14. The image pickup device of claim 10, wherein the first image pickup unit detects a luminance image.

15. The image pickup device of claim 10, wherein the first image pickup unit detects a single color image to be used as a luminance image.

16. The image pickup device of claim 10, wherein the second image pickup unit comprises three or more lenses.

17. The image pickup device of claim 10, wherein the first image pickup unit and second image pickup unit have different resolutions.

18. A method of processing image data obtained from an imaging device with a first image pickup unit and a second image pickup unit, the first image pickup unit and the second image pickup unit having different viewpoints, the method comprising:
acquiring a first image from a first viewpoint;
acquiring a second image from a second viewpoint;
determining a point in the second image which corresponds to a reference point in the first image;
adjusting a pixel location for the point in the second image which corresponds to the reference point in the first image to form a deformed image having a viewpoint approximately corresponding to the first viewpoint; and
interpolating pixel values for points in the deformed image not having a determined correspondence between the first image and the second image.

19. The method of claim 18, further comprising:
generating a synthesized image from the first image and the interpolated image.

20. The method of claim 19, further comprising:
selecting an output image from the group of images including the synthesized image, the first image, and the second image, the selection based on parallax information and chrominance information.
